(19) United States
(12) Patent Application Publication
(10) Pub. No.: US 2015/0248669 A1
(43) Pub. Date: Sep. 3, 2015

(54) SYSTEMS AND METHODS FOR MANAGING GIFT CARDS

(71) Applicant: Capital One Financial Corporation, McLean, VA (US)

(72) Inventors: Kelly M. Kornman, Mechanicsville, VA (US); Rachel S. Beck, Charlottesville, VA (US); Heather H. Marcel, Glen Allen, VA (US); Emily K. DeLyser, Richmond, VA (US); Chad E. Kendall, Hockessin, DE (US)

(73) Assignee: CAPITAL ONE FINANCIAL CORPORATION, McLean, VA (US)

(21) Appl. No.: 14/634,249

(22) Filed: Feb. 27, 2015

Related U.S. Application Data
(60) Provisional application No. 61/946,121, filed on Feb. 28, 2014.

(51) Int. Cl. G06Q 20/34; G06Q 20/10

(52) U.S. Cl. CPC G06Q 20/342; G06Q 40/02; G06Q 20/10

(57) ABSTRACT

A system for linking a gift card with a financial account of a financial service provider may include one or more memory devices storing instructions and one or more processors configured to receive gift card data including a credit balance of a gift card associated with a user. The processor may be configured to determine a financial account of the user with the financial service provider and associate the gift card data with the financial account of the user. Additionally, the processor may be configured to receive transaction data for a purchase transaction of the user at a merchant. The transaction data may include an identifier of the financial account of the user. Based on the identifier of the financial account of the user, the processor may be further configured to apply at least a portion of the credit balance of the gift card to the purchase transaction.

### PRIORITY CLAIM

This disclosure claims priority under 35 U.S.C. §119 to U.S. provisional patent application No. 61/946,121 filed on Feb. 28, 2014, and entitled “Systems and Methods for Managing Gift Cards.” The aforementioned application is incorporated herein by reference in its entirety.

### TECHNICAL FIELD

The disclosed embodiments generally relate to systems and methods for managing gift cards and, more particularly, to systems and methods for managing gift cards by associating them with a financial service provider account.

### BACKGROUND

Consumers often rely on gift cards when making purchases from various merchants. Consumers may receive gift cards as gifts, or may prefer to use reloadable pre-paid gift cards as a way to manage spending. Typical gift card redemption systems require a consumer to present the physical gift card during check out when making a purchase at a merchant who accepts the gift card as payment. Payment is then deducted from the balance on the gift card and the gift card is returned to the consumer.

While many consumers enjoy receiving and using gift cards as a way to purchase goods, managing them can be difficult, cumbersome, and confusing for consumers. For example, keeping up with many physical cards can be a daunting task, and ensuring that one has the card for the proper merchant can require expenditure of effort in foresight and planning. Also, consumers often find it difficult to keep track of the balance on various gift cards and run the risk of forfeiting the card's balance if the card is lost. Typically, to check the remaining balance on a card, a consumer must call a toll free number listed on the back of the card, enter a number assigned to the gift card on the issuing merchant's website, or bring the card to the issuing merchant. Therefore, there exists a need to provide consumers with more effective ways to manage gift cards without requiring retention of the cards themselves.

### SUMMARY

In the following description, certain aspects and embodiments of the present disclosure will become evident. It should be understood that the disclosure, in its broadest sense, could be practiced without having one or more features of these aspects and embodiments. It should also be understood that these aspects and embodiments are merely exemplary.

The present disclosure provides improved systems and methods for managing gift cards from various merchants without needing to retain the physical card. For example, the disclosed embodiments may enable consumers to manage gift cards by storing or linking them with a financial service provider account. The disclosed embodiments may provide services that are valuable to both consumers and financial service providers. For example, aspects of the disclosed embodiments provide a user with a method for storing and using gift cards to various merchants using, for example, a credit or debit account provided by a financial service provider. For consumers, aspects of the disclosed embodiments allow them to easily keep track of their gift cards and manage their gift card balances. This may help consumers to avoid losing gift card balances due to lost or forgotten gift cards. For financial service providers, aspects of the disclosed embodiments allow them to attract new customers and encourage current customers to use the financial service provider's accounts more often when making purchases. For example, if a user uses a gift card associated with a financial service provider account and the gift card has insufficient funds to cover the entire cost of the transaction, the user will likely charge the remaining balance to the financial service provider's account.

Other aspects of the disclosed embodiments are set forth below in this disclosure. For example, the disclosed embodiments include a system for linking a gift card with a financial account of a financial service provider. The system may include, for example, one or more memory devices storing instructions and one or more processors configured to execute the instructions. The one or more processors may be configured to execute the instructions in order to receive gift card data associated with a gift card a user. The gift card data may include a credit balance of a gift card. The processor may be configured to determine a financial account of the user with a financial service provider and associate the gift card data with the financial account of the user. Additionally, the processor may be configured to receive transaction data for a purchase transaction of the user at a merchant. The transaction data may include an identifier of the financial account of the user. Based on the identifier of the financial account of the user, the processor may be further configured to apply at least a portion of the credit balance of the gift card to the purchase transaction and apply a remaining balance of the purchase transaction to the financial account of the user.

The disclosed embodiments also include a computer-implemented method for linking a gift card with a financial account of a financial service provider. The method may include, for example, receiving gift card data associated with a user. The gift card data may include a credit balance of a gift card. The method may further include determining a financial account of the user with the financial service provider and associating the gift card data with the financial account of the user. Additionally, the method may include receiving transaction data for a purchase transaction of the user at a merchant. The transaction data may include an identifier of the financial account of the user. Based on the identifier of the financial account of the user, the method may further include applying at least a portion of the credit balance of the gift card to the purchase transaction and applying a remaining balance of the purchase transaction to the financial account of the user.

In accordance with additional embodiments of the present disclosure, a computer-readable medium is disclosed that stores instructions that, when executed by a processor(s), causes the processor(s) to perform processes consistent with disclosed embodiments.

It is to be understood that both the foregoing general description and the following detailed description are exemplary and explanatory only, and are not restrictive of the disclosed embodiments, as claimed.

### BRIEF DESCRIPTION OF THE DRAWINGS

The accompanying drawings, which are incorporated in and constitute a part of this specification, illustrate several embodiments and, together with the description, serve to explain the disclosed principles. In the drawings:

FIG. 1 is a block diagram of an exemplary system, consistent with the disclosed embodiments;

FIG. 2 is a block diagram of an exemplary computer system, consistent with the disclosed embodiments;

FIG. 3 is a flowchart of an exemplary process for managing gift cards, consistent with the disclosed embodiments;

FIG. 4 is a flowchart of an exemplary process for determining whether a gift card may be applied to a purchase transaction, consistent with the disclosed embodiments;

FIG. 5 is a flowchart of an exemplary process for applying a gift card to a purchase transaction, consistent with the disclosed embodiments;

FIG. 6 is a flowchart of an exemplary process for front-end application of a gift card to a purchase transaction, consistent with the disclosed embodiments;

FIG. 7 is a flowchart of an exemplary process for back-end application of a gift card to a purchase transaction, consistent with the disclosed embodiments;

FIG. 8 is an example of a user device displaying a gift card summary screen, consistent with the disclosed embodiments;

FIG. 9 is an example of a user device displaying a recent activity screen, consistent with the disclosed embodiments;

FIG. 10 is an example of a user device displaying a mobile payment screen, consistent with the disclosed embodiments.

### DETAILED DESCRIPTION

Reference will now be made in detail to exemplary embodiments, examples of which are illustrated in the accompanying drawings and disclosed herein. Wherever convenient, the same reference numbers will be used throughout the drawings to refer to the same or like parts.

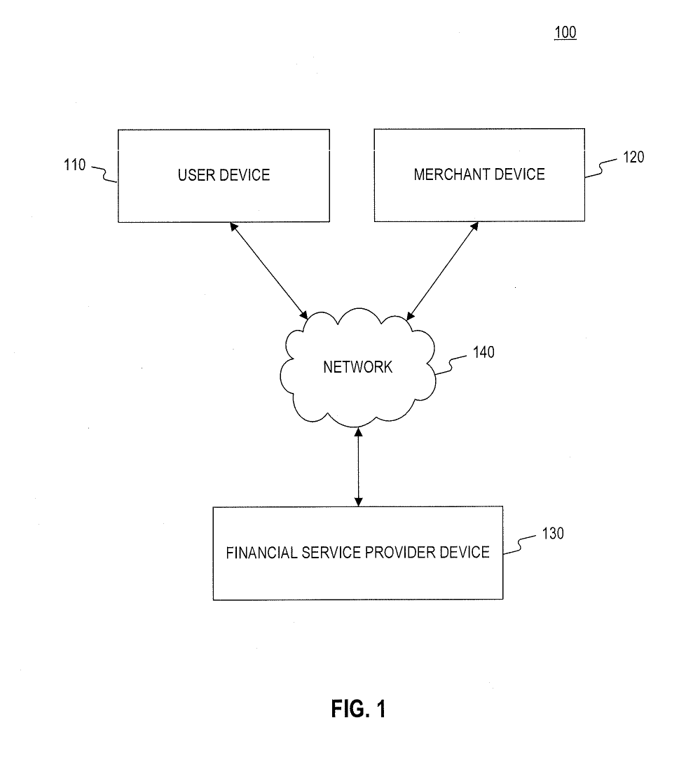

FIG. 1 shows a diagram of an exemplary system 100 that may be configured to manage gift cards, consistent with disclosed embodiments. As shown in FIG. 1, system 100 may include a user device 110, a merchant device 120, a financial service provider device 130, and a network 140 to facilitate communication among the components of system 100. The components and arrangement of the components included in system 100 may vary. Thus, system 100 may further include other components that perform or assist in the performance of one or more processes consistent with the disclosed embodiments. The components and arrangements shown in FIG. 1 are not intended to limit the disclosed embodiments, as the components used to implement the disclosed processes and features may vary.

In accordance with disclosed embodiments, a financial discount system 100 may include a financial service provider (FSP) device 130. FSP device 130 may be a system associated with a financial service provider (not shown), such as a bank, a credit card company, a lender, brokerage firm, or any other type of financial service entity that generates, provides, manages, and maintains financial service accounts, manages gift cards etc. for one or more users. FSP device 130 may be one or more computing systems that are configured to execute software instructions stored on one or more memory devices to perform one or more operations consistent with the disclosed embodiments. For example, FSP device 130 may include one or more memory device(s) storing data and software instructions and one or more processor(s) configured to use the data and execute the software instructions to perform server-based functions and operations known to those skilled in the art. FSP device 130 may include one or more general purpose computers, mainframe computers, or any combination of these types of components.

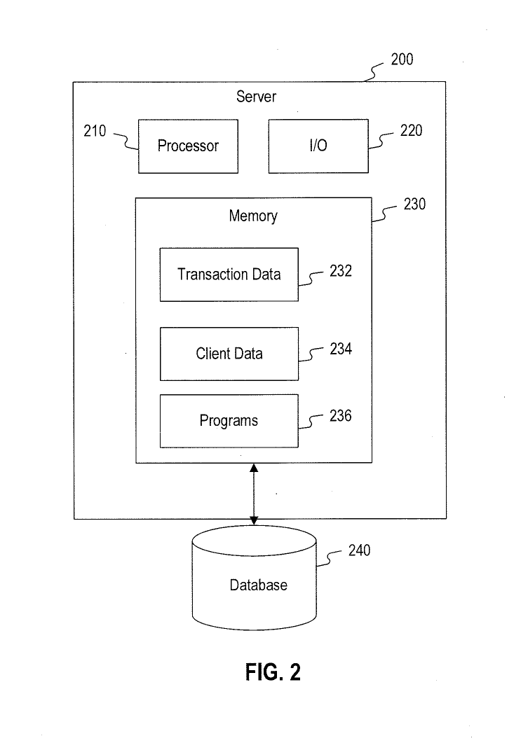

In certain embodiments, FSP device 130 may be configured as a particular apparatus, system, and the like based on the storage, execution, and/or implementation of the software instructions that perform one or more operations consistent with the disclosed embodiments. FSP device 130 may be standalone, or it may be part of a subsystem, which may be part of a larger system. For example, FSP device 130 may represent distributed servers that are remotely located and communicate over a network (e.g., network 140) or a dedicated network, such as a LAN, for a financial service provider. An exemplary computing system consistent with FSP device 130 is discussed in additional detail with respect to FIG. 2, below.

FSP device 130 may include or may access one or more storage devices configured to store data and/or software instructions used by one or more processors of FSP device 130 to perform operations consistent with disclosed embodiments. For example, FSP device 130 may include memory configured to store one or more software programs that perform several functions when executed by a processor. The disclosed embodiments are not limited to separate programs or computers configured to perform dedicated tasks. For example, FSP device 130 may include memory that stores a single program or multiple programs. Additionally, FSP device 130 may execute one or more programs located remotely from FSP device 130. For example, FSP device 130 may access one or more remote programs stored in memory included with a remote component that, when executed, perform operations consistent with the disclosed embodiments. In certain aspects, FSP device 130 may include server software that generates, maintains, and provides services associated with gift card management. In other aspects, FSP device 130 may connect with separate server(s) or similar computing devices that generate, maintain, and provide services associated with financial data for a financial service provider associated with FSP device 130.

System 100 may also include one or more merchant devices 120. Merchant device 120 may be a computing system that is associated with a merchant or other business entity that provides goods and/or services, such as a retailer, grocery store, service provider (e.g., utilities, etc.), or any other type of entity that provides goods and/or services that consumers (e.g., user, charity, etc.) may purchase. While system 100 is shown with one merchant device 120, the disclosed embodiments may be implemented in a system including two or more merchant devices 120 associated with any number of underlying business entities. Further, merchant device 120 is not limited to conducting business in any particular industry or field.

Merchant device 120 may be associated with a merchant brick and mortar location(s) that a user may physically visit and purchase goods and services. Such physical locations may include merchant devices 120, which may include computing devices that perform financial service transactions with consumers (e.g., Point of Sale (POS) terminal(s), kiosks, etc.). Merchant device 120 may also include back and/or front-end computing components that store data and execute software instructions to perform operations consistent with disclosed embodiments, such as computers that are operated by employees of the merchant (e.g., back office systems, etc.). Merchant device 120 may also be associated with a merchant that provides goods and/or services via known online or e-commerce type of solutions. For example, such a merchant may sell goods via a website using known online or e-commerce systems and solutions to market, sell, and process online transactions.

In one embodiment, merchant device 120 may include one or more servers or other type of computer devices. The merchant system server(s) may be one or more computing devices configured to execute software instructions stored in memory to perform one or more processes consistent with the disclosed embodiments. For example, merchant device 120 may include one or more memory device(s) storing data and software instructions and one or more processor(s) configured to use the data and execute the software instructions to perform server-based functions and operations known to those skilled in the art.

Merchant device 120 may further include server(s) that are configured to execute stored software instructions to perform operations associated with a merchant, including one or more processes associated with processing purchase transactions, generating transaction data, and generating product data (e.g., SKU data) relating to purchase transactions, etc. Merchant device 120 may include one or more servers that may be a general purpose computer, a mainframe computer, or any combination of these components. In certain embodiments, merchant device 120 (or a system including merchant device 120) may be configured as a particular apparatus, system, and the like based on the storage, execution, and/or implementation of the software instructions that perform one or more operations consistent with the disclosed embodiments. A merchant server may be standalone, or it may be part of a subsystem, which may be part of a larger system. For example, a merchant server may represent distributed servers that are remotely located and communicate over a network (e.g., network 140) or a dedicated network, such as a LAN. An exemplary computer system consistent with merchant device 120 is discussed in additional detail with respect to FIG. 2.

In certain aspects, merchant device 120 may include one or more web servers that execute software that generates, maintains, and provides web site(s) for a respective merchant that is accessible over network 140. In other aspects, a merchant device 120 may connect separately to web server(s) or similar computing devices that generate, maintain, and provide web site(s) for a merchant.

In certain embodiments, a merchant may operate components associated with merchant device 120 to perform one or more processes consistent with the disclosed embodiments. For example, merchant device 120 may be configured to execute software instructions to provide transaction data and/or product data relating to purchase transactions to FSP device 130 over network 140.

System 100 may further include one or more user devices 110. A user may operate a user device 110, which may be a desktop computer, laptop, tablet, smartphone, multifunctional watch, pair of multifunctional glasses, tracking device, or any suitable device with computing capability. User device 110 may have a financial application installed thereon, which may enable user device 110 to communicate with FSP device 130 via network 140. Alternatively, user device 110 may connect to FSP device 130 and/or merchant device 120 through use of browser software. User device 110 may allow a user to access information stored in FSP device 130, such as, for example, financial information related to recent purchase transactions, financial discounts, financial statements, account information, rewards program information, stored gift card information and the like. An exemplary computer system consistent with user device 110 is discussed in additional detail with respect to FIG. 2.

A user may operate user device 110 to perform one or more operations consistent with the disclosed embodiments. In one aspect, a user may be a customer of financial service provider 110. For instance, a financial service provider may maintain a financial service account (e.g., credit card account) for the user that the user may use to purchase goods and/or services online or at brick and mortar locations associated with a merchant relating to merchant device 120. Consistent with disclosed embodiments, a user may operate user device 110 to initiate a purchase transaction with a merchant or merchant device 120 and receive communications associated with gift card data and redemption. Further, a user may operate user device 110 to view a financial service account or financial statement provided by a financial service provider or FSP device 130.

Network 140 may comprise any type of computer networking arrangement used to exchange data. For example, network 140 may be the Internet, a private data network, a virtual private network using a public network, a WiFi network, a LAN or WAN network, and/or other suitable connections that may enable information exchange among various components of the discount system 100. Network 140 may also include a public switched telephone network (“PSTN”) and/or a wireless cellular network. Network 140 may be a secured network or unsecured network. In other embodiments, one or more components of system 100 may communicate directly through a dedicated communication link(s), such as links between FSP device 130 and merchant device 120.

Other components known to one of ordinary skill in the art may be included in system 100 to process, transmit, provide, and receive information consistent with the disclosed embodiments. In addition, although not shown in FIG. 1, components of system 100 may communicate with each other through direct communications, rather than through network 140. Direct communications may use any suitable technologies, including, for example, Bluetooth™, Bluetooth LE™, WiFi, near field communications (NFC), or other suitable communication methods that provide a medium for transmitting data between separate devices.

FIG. 2 shows a diagram of an exemplary computing system 200 illustrating a computing system configuration that may be associated with FSP device 130, merchant device 120, and/or user device 110, consistent with disclosed embodiments. In one embodiment, computing system 200 may have one or more processors 210, one or more memories 230, and one or more input/output (I/O) devices 220. In some embodiments, computing system 200 may take the form of a server, general purpose computer, a mainframe computer, laptop, smartphone, mobile device, or any combination of these components. In certain embodiments, computing system 200 (or a system including computing system 200) may be configured as a particular apparatus, system, and the like based on the storage, execution, and/or implementation of the software instructions that perform one or more operations consistent with the disclosed embodiments. Computing system 200 may be standalone, or it may be part of a subsystem, which may be part of a larger system.

Processor 210 may include one or more known processing devices, such as a microprocessor from the Pentium™ or Xeon™ family manufactured by Intel™, the Turion™ family manufactured by AMD™, or any of various processors manufactured by Sun Microsystems, for example. Processor 210 may constitute a single core or multiple core processor that executes parallel processes simultaneously. For example, processor 210 may be a single core processor configured with virtual processing technologies. In certain embodiments, processor 210 may use logical processors to simultaneously execute and control multiple processes. Processor 210 may implement virtual machine technologies, or other known technologies to provide the ability to execute, control, run, manipulate, store, etc. multiple software processes, applications, programs, etc. In another embodiment, processor 210 may include a multiple-core processor arrangement (e.g., dual, quad core, etc.) configured to provide parallel processing functionalities to allow computing system 200 to execute multiple processes simultaneously. One of ordinary skill in the art would understand that other types of processor arrangements could be implemented that provide for the capabilities disclosed herein. The disclosed embodiments are not limited to any type of processor(s) configured in computing system 200.

Memory 230 may include one or more storage devices configured to store instructions used by processor 210 to perform functions related to the disclosed embodiments. For example, memory 230 may be configured with one or more software instructions, such as program(s) 236 that may perform one or more operations when executed by processor 210. The disclosed embodiments are not limited to separate programs or computers configured to perform dedicated tasks. For example, memory 230 may include a program 236 that performs the functions of computing system 200, or program 236 could comprise multiple programs. Additionally, processor 210 may execute one or more programs located remotely from computing system 200. For example, FSP device 130, merchant device 120, or user device 110, may, via computing system 200 (or variants thereof), access one or more remote programs that, when executed, perform functions related to certain disclosed embodiments. Processor 210 may further execute one or more programs located in database 240. In some embodiments, programs 236 may be stored in an external storage device, such as a cloud server located outside of computing system 200, and processor 210 may execute programs 236 remotely.

Programs executed by processor 210 may cause processor 210 to execute one or more processes related to financial services provided to users including, but not limited to, processing credit and debit card transactions, checking transactions, fund deposits and withdrawals, transferring money between financial accounts, lending loans, processing payments for credit card and loan accounts, and managing gift cards.

Memory 230 may also store data that may reflect any type of information in any format that the system may use to perform operations consistent with the disclosed embodiments. Memory 230 may store instructions to enable processor 210 to execute one or more applications, such as server applications, a gift card management application, network communication processes, and any other type of application or software. Alternatively, the instructions, application programs, etc., may be stored in an external storage (not shown) in communication with computing system 200 via network 140 or any other suitable network. Memory 230 may be a volatile or non-volatile, magnetic, semiconductor, tape, optical, removable, non-removable, or other type of storage device or tangible (i.e., non-transitory) computer-readable medium.

Memory 230 may include transaction data 232. Transaction data 232 may include information related to purchase transactions initiated by a user. For example, transaction data may include a user identifier and a purchase price. The user identifier may be a credit or debit card number, an account number, or another means for identifying the user initiating the purchase transaction. The purchase price may include a number representing the total sale price of the purchase transaction and/or may include a list of the various items purchased from the merchant. In some embodiments, merchant device 120 may collect, generate, and provide transaction data relating to purchase transactions involving a user to FSP device 130. In some embodiments, merchant device 120 may further provide product data (e.g., SKU data) and transaction data relating to purchase transactions involving a user to FSP device 130. Merchant device 120 may provide this information to FSP device 130 via network 140. Alternatively transaction data 232 may be stored in database 240 or in an external storage (not shown) in communication with computing system 200 via network 140 or any other suitable network.

Memory 230 may further include client data 234. Client data 234 may include information about particular clients of the financial service provider. For example, client data 234 may include clients' account information, debit or credit card information, history of purchase transactions, financial statements, credit score, risk profile, and/or gift card data. Client data 234 may further contain one or more user profiles associating the account information, debit or credit card information, history of purchase transactions, financial statements, credit score, risk profile, and/or gift card information, including stored gift cards. When a user initiates a purchase transaction, processor 210 may analyze client data 234 or user profiles before authorizing the purchase transaction on behalf of a user. Alternatively, client data 234 may be stored in database 240 or in an external storage (not shown) in communication with computing system 200 via network 140 or any other suitable network.

Processor 210 may analyze transaction data 232 in reference to client data 234. For example, processor 210 may analyze transaction data to determine which client with information stored in client information 234 is initiating the purchase transaction. Processor 210 may access the particular user's client information to determine their account information, debit or credit card information, history of purchase transactions, financial statements, credit score, risk profile, and/or gift card information.

I/O devices 220 may be one or more device that is configured to allow data to be received and/or transmitted by computing system 200. I/O devices 220 may include one or more digital and/or analog communication devices that allow computing system 200 to communicate with other machines and devices, such as other components of system 100 shown in FIG. 1. For example, computing system 200 may include interface components, which may provide interfaces to one or more input devices, such as one or more keyboards, mouse devices, and the like, which may enable computing system 200 to receive input from an operator of FSP device 130 (not shown).

Computing system 200 may also contain one or more database(s) 240. Alternatively, computing system 200 may be communicatively connected to one or more database(s) 240. Computing system 200 may be communicatively connected to database(s) 240 through network 140. Database 240 may include one or more memory devices that store information and are accessed and/or managed through computing system 200. By way of example, database(s) 240 may include Oracle™ databases, Sybase™ databases, or other relational databases or non-relational databases, such as Hadoop sequence files, HBase, or Cassandra. The databases or other files may include, for example, data and information related to the source and destination of a network request, and the data contained in the request, etc. Systems and methods of disclosed embodiments, however, are not limited to separate databases. Database 240 may include computing components (e.g., database management system, database server, etc.) configured to receive and process requests for data stored in memory devices of database(s) 240 and to provide data from database 240.

As discussed above, FSP device 130 may include at least one computing system 200. Further, although sometimes discussed here in relation to FSP device 130, it should be understood that variations of computing system 200 may be used by other components of system 100, including merchant device 120 and user device 110. Computing system 200 may be a single server or may be configured as a distributed computer system including multiple servers or computers that interoperate to perform one or more of the processes and functionalities associated with the disclosed embodiments.

In some aspects, merchant device 120 may include the same or similar configuration and/or components of computing system 200. Computing system 200 when implemented in merchant device 120 may include hardware and/or software installed therein for performing methods and processes disclosed herein. Computing system 200 may also enable merchant device 120 to sell products and/or services via network 140. For example, a user may use user device 110 to browse a webpage hosted or otherwise associated with merchant device 120 that runs on computing system 200, and may make a purchase of products or services offered by merchant 120 via the webpage. In other embodiments, a user may initiate a purchase at a brick and mortar establishment associated with merchant, and merchant device 120 (via, e.g., computing system 200, which may be a point of sale terminal in some embodiments) may communicate with FSP device 130 over network 140 to authorize the purchase. For example, a user may use a bank card managed by a financial service provider to purchase products or services from a merchant operating merchant device 120, and merchant device 120 may transmit information related to the transaction to computing system 200 of the financial service provider in order to, for example, verify authentication information about the bank card used by user. In some embodiments, merchant device 120 may additionally obtain additional information related to the user, for example the user's and/or transaction's discount eligibility.

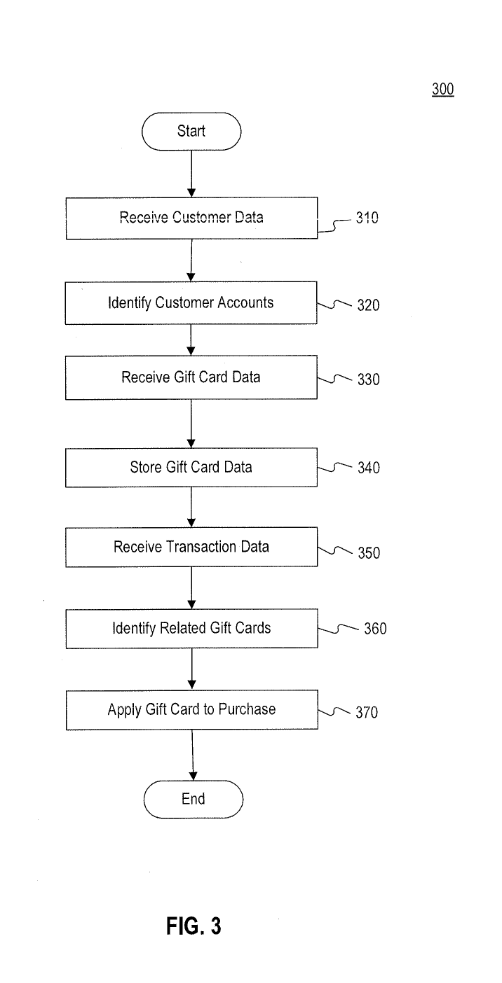

FIG. 3 shows an exemplary gift card management process 300, consistent with disclosed embodiments. Process 300 may be performed by processor 210 of, for example, FSP device 130 executing instructions encoded on a computer-readable medium storage device. It is to be understood, however, that one or more steps of process 300 may be implemented by other components of system 100 (shown or not shown), including merchant device 120 and/or user device 110. At step 310, FSP device 130 may receive customer data relating to a customer of a financial service provider. FSP device 130 may receive customer data over network 140 from, for example, user device 110. Customer data may be entered manually by the user into user device 110 by typing it on a keyboard or other input device (not shown). Customer data may also be entered automatically, for example by scanning or swiping a credit or debit card on user device 110 or merchant device 120 that may contain customer data pertaining to the user, or by taking a picture of a credit or debit card using a mobile application that may be installed on user device 110.

FSP device 130 may use the customer data to identify one or more customer accounts associated with the user (step 320). For example, FSP device 130 may compare customer data received from user device 110 or merchant device 120 with client data 234 to identify one or more customer accounts associate with the user (using, e.g., a financial account identifier indicated in the customer data).

At step 330, FSP device 130 may receive gift card data associated with one or more gift cards owned or obtained by a user. Gift card data may include, for example, a merchant identifier identifying the merchant at which the gift card is redeemable and a value identifying the amount of credit on the gift card. Gift card data may additionally include a gift card identifier number or serial number identifying the particular gift card for which data has been received. Gift card data may be received by FSP device 130 from, for example, user device 110. For example, gift card data may be entered manually by the user into user device 110 by typing it on a keyboard or other input device (not shown). Gift card data may also be entered automatically, for example, by scanning or swiping the gift card on user device 110 or merchant device 120, or by taking a picture of the gift card using an application that may be installed on user device 110.

FSP device 130 may store received gift card data in memory 230 (step 340). For example, FSP device 130 may store the received gift card data in client data 234, in relation to the customer account identified in step 320. Additionally or alternatively, FSP device 130 may store the received gift card data in database 240. FSP device 130 may associate gift card data stored in database 240 with the customer account identified in step 320. Associating the received gift card data with the customer account identified in step 230 may be accomplished, for example, by linking the gift card data with the customer account or by creating a subcategory of memory associated with the customer account for storing gift card data such as that received by FSP device 130 in step 330.

At step 350, FSP device 130 may receive transaction data relating to one or more purchase transactions. Transaction data may include, for example, a customer identifier in order to identify the customer account associated with the purchase transaction, a purchase price indicating the amount of the purchase transaction, and a merchant identifier indicating the merchant from which the purchase transaction is being executed. Merchant device 120 may collect transaction data at the point of sale, for example, by processing a user's credit or debit card, and transmit the transaction data to FSP device 130 as part of authorizing the purchase transaction in payment for a product or service provided by a merchant. This transaction data may be transmitted to FSP device 130 over network 140. Merchant device 120 may transmit the transaction data via I/O 220 as implemented within merchant device 120. I/O 220 in computing system 200 implemented in FSP device 130 may receive the transaction data. In some embodiments, FSP device 130 may store the transaction data in memory 230 (e.g., in transaction data 232).

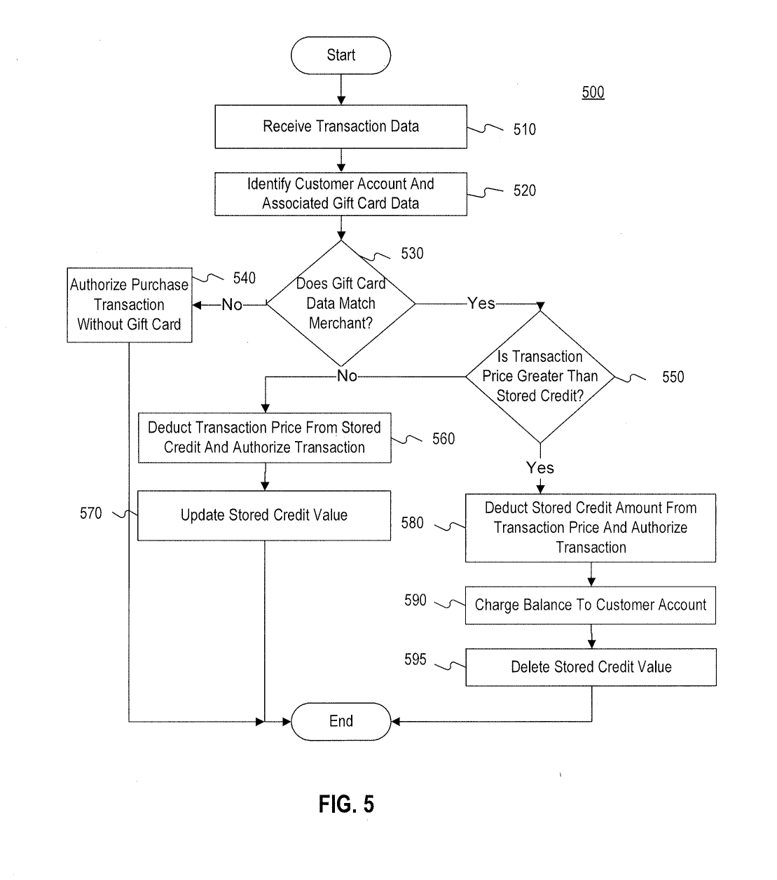

Based on the transaction data received in step 350, FSP device 130 may identify related gift cards (step 360). For example, based on the received transaction data, FSP device 130 may identify a customer account from which the purchase transaction will be processed. The customer account may be identified, for example, by use of a customer identifier which may be contained in the received transaction data. The customer identifier may be associated with a customer account. FSP device 130 may then search for any gift card data stored in association with the identified customer account. Once FSP device 130 identifies any gift card data associated with the customer account, it may identify if any gift card is able to be applied to the purchase transaction. FSP device 130 may determine if any gift card may be applied to the purchase transaction by comparing a merchant identifier received in the transaction data to the merchant identifiers stored in the gift card data associated with the customer account. If FSP device 130 identifies a gift card with a merchant identifier that matches that of the purchase transaction, it may apply the gift card to the purchase transaction (step 370). Applying the gift card will be discussed in further detail with respect to FIG. 5.

Additionally or alternatively, FSP device 130 may send a message to a user to ask the user initiating the purchase transaction whether they wish to apply the identified gift card to the purchase transaction. A message may be sent to the user, for example, across network 140 to user device 110. The message may, for example, comprise email, SMS, MMS, phone, and/or RMS.

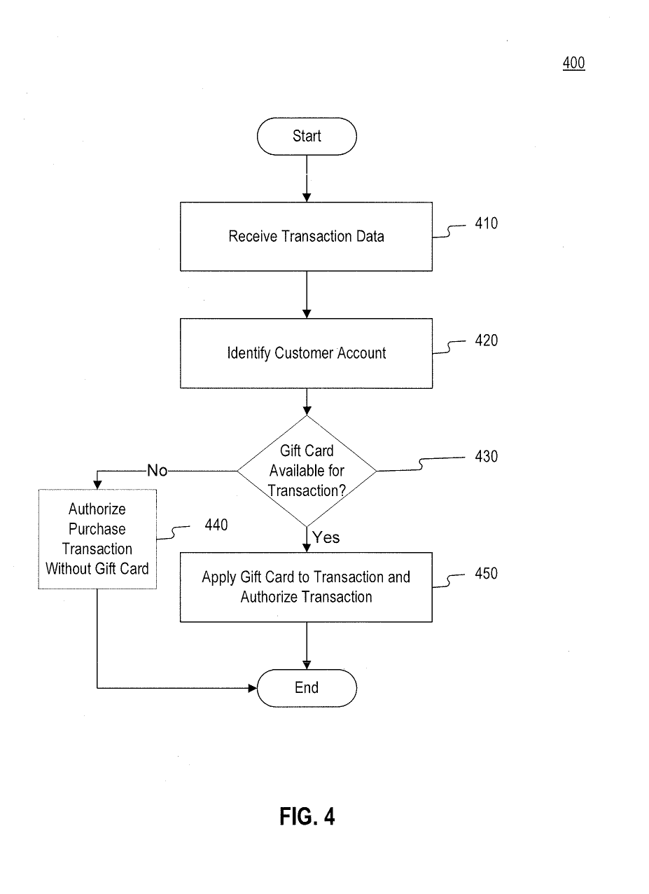

FIG. 4 shows an exemplary gift card management process 400, consistent with disclosed embodiments. Process 400 may be performed by processor 210 of, for example, FSP device 130 executing instructions encoded on a computer-readable medium storage device. It is to be understood, however, that one or more steps of process 400 may be implemented by other components of system 100 (shown or not shown), including merchant device 120 and/or user device 110.

At step 410, as also discussed with reference to FIG. 3, FSP device 130 may receive transaction data relating to one or more purchase transactions. Transaction data may include, for example; a customer identifier in order to identify the customer account associated with the purchase transaction, a purchase price indicating the amount of the purchase transaction, and a merchant identifier indicating the merchant from which the purchase transaction is being executed. Merchant device 120 may collect transaction data at the point of sale, for example, by processing a user's credit or debit card, and transmit the transaction data to FSP device 130 as part of authorizing the purchase transaction in payment for a product or service provided by a merchant. This transaction data may be transmitted to FSP device 130 over network 140. Merchant device 120 may transmit the transaction data via I/O 220 as implemented within merchant device 120. I/O 220 in computing system 200 implemented in FSP device 130 may receive the transaction data. In some embodiments, this data may be stored in memory 230, for example, in transaction data 232.

Based on the received transaction data, as also discussed with reference to FIG. 3, FSP device 130 may identify one or more related customer accounts (step 420). For example, based on the received transaction data, processor 210 may identify a customer account from which the purchase transaction will be processed. The customer account may be identified, for example, by use of a customer identifier which may be contained in the received transaction data. The customer identifier may be associated with a customer account. Processor 210 may then search for any gift card data stored in association with the identified customer account. Once processor 210 identifies any gift card data associated with the customer account, it may identify if any gift card is able to be applied to the purchase transaction. Determining if any gift card may be applied to the purchase transaction may be done by comparing a merchant identifier received in the transaction data to the merchant identifiers stored in the gift card data associated with the customer account (step 430).

If FSP device 130 does not find a gift card with a merchant identifier that matches that of the purchase transaction (step 430—No), then FSP device 130 will authorize the purchase transaction without applying a gift card (step 440). To authorize the purchase transaction, FSP device 130 may transmit authorization for the purchase transaction back to merchant device 120. Authorization may be transmitted across network 140.

If FSP device 130 finds a gift card with a merchant identifier that matches that of the purchase transaction (step 430—Yes), it may apply the gift card to the purchase transaction (step 450). FSP device 130 may also authorize the purchase transaction by transmitting an authorization to merchant device 120. Applying the gift card will be discussed in further detail with respect to FIG. 5.

FIG. 5 shows an exemplary process for applying a stored gift card to a purchase transaction. Process 500 may be performed by processor 210 of, for example, FSP device 130 executing instructions encoded on a computer-readable medium storage device. It is to be understood, however, that one or more steps of process 500 may be implemented by other components of system 100 (shown or not shown), including merchant device 120 and/or user device 110.

At step 510, FSP device 130 may receive transaction data from one or more purchase transactions. Transaction data may include, for example, a customer identifier of the customer account associated with the purchase transaction, a purchase price indicating the amount of the purchase transaction, and a merchant identifier indicating the merchant from which the purchase transaction is being executed. Merchant device 120 may collect transaction data at the point of sale, for example, by processing a user's credit or debit card, and transmit the transaction data to FSP device 130 as part of authorizing the purchase transaction in payment for a product or service provided by a merchant. This transaction data may be transmitted to FSP device 130 over network 140. Merchant device 120 may transmit the transaction data via I/O 220 as implemented within merchant device 120. I/O 220 in computing system 200 implemented in FSP device 130 may receive the transaction data. In some embodiments, this data may be stored in memory 230, for example, in transaction data 232.

Based on the received transaction data, as also discussed with reference to FIG. 3, FSP device 130 may identify one or more related customer accounts and any gift card data associated with the identified customer account (step 520). For example, based on the received transaction data, processor 210 may identify a customer account from which the purchase transaction will be processed. The customer account may be identified, for example, by use of a customer identifier which may be contained in the received transaction data. The customer identifier may be associated with a customer account. Processor 210 may then search for any gift card data stored in association with the identified customer account. Once processor 210 identifies any gift card data associated with the customer account, it may identify if any gift card is able to be applied to the purchase transaction. Determining if any gift card may be applied to the purchase transaction may be done by comparing a merchant identifier received in the transaction data to the merchant identifiers stored in the gift card data associated with the customer account (step 530).

If FSP device 130 does not find a gift card with a merchant identifier that matches that of the purchase transaction, then FSP device 130 may authorize the purchase transaction without applying a gift card (step 540). To authorize the purchase transaction, FSP device 130 may transmit authorization for the purchase transaction back to merchant device 120. Authorization may be transmitted across network 140.

If FSP device 130 does find a gift card with a merchant identifier that matches that of the purchase transaction, then FSP device 130 may determine if the transaction price for the purchase transaction is greater than the value of the stored credit for the merchant of the identified gift card (step 550). If the transaction price is not greater than the value of the stored credit, then FSP device 130 may deduct the transaction price from the value of the stored credit (step 560). FSP device 130 may then update the stored credit value to be the balance remaining on the gift card following the deduction (step 570). Updating the stored credit value may be done by processor 210 overwriting the stored gift card data for the identified gift card used in the purchase transaction. FSP device 130 may additionally notify the user that the gift card has been used, and also notify the user of the updated remaining balance on the gift card.

If FSP device 130 determines in step 550 that the transaction price is greater than the value of the stored credit, then FSP device 130 may deduct the value of the stored credit from the transaction price (step 580). FSP device 130 may then charge the remaining balance to the customer account identified in step 520 and authorize the transaction (step 590). Charging the remaining balance to the customer account may comprise charging the remaining balance to the debit or credit card used by the user in initiating the purchase transaction.

FSP device 130 may then adjust the balance of the stored credit value remaining on the identified gift card to reflect the redemption (step 595). FSP device 130 may adjust the balance by, for example, overwriting the stored gift card data for the identified gift card used in the purchase transaction with a zero value. Additionally or alternatively, FSP device 130 may adjust the balance by deleting the stored credit value or erasing and/or overwriting all gift card data associated with the used or redeemed gift card. FSP device 130 may additionally notify the user that the gift card has been used, and also notify the user that the gift card has no remaining balance. As discussed herein, deletion of data may include identifying certain data that is available to be overwritten.

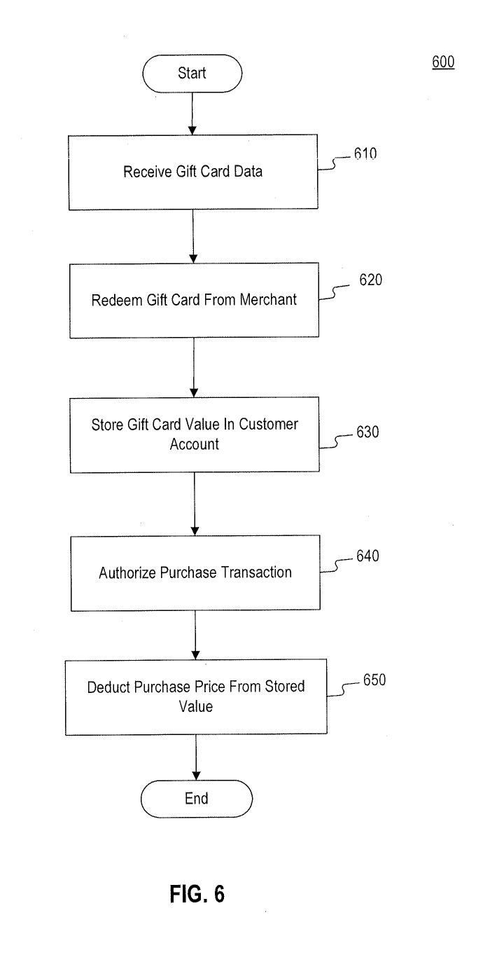

FIG. 6 shows a process for managing gift cards by a financial service provider with a front-end application, consistent with the disclosed embodiments. With a front-end application, a financial service provider may redeem the gift card from the merchant prior to its in-store redemption by the customer. At step 610, FSP device 130 may receive gift card data. Receiving gift card data may be accomplished in similar fashion to the previous disclosures with reference to FIGS. 3, 4, and 5.

At step 620, the financial service provider may redeem the stored gift card from the merchant. Redeeming the gift card from the merchant may comprise contacting, for example over a network 140, the merchant that issued the gift card and receiving from the merchant the value of the gift card. The FSP device 130 may also store the received gift card data in association with a customer account, as also disclosed in relation to FIGS. 3, 4, and 5 (step 630). FSP device 130 may store the value of the gift card in a customer account either before or after redeeming the gift card from the merchant.

Once a user who has the gift card stored in their customer account chooses to redeem the gift card at the merchant (as discussed in detail with respect to FIGS. 3, 4, and 5), FSP device 130 may authorize the transaction (step 640). FSP device 130 may authorize the transaction in the same way it would authorize any transaction paid for by a user's debit or credit card issued by the financial service provider. FSP device 130 may then generate a financial statement that reflects the amount that the user redeemed from the gift card. FSP device 130 may update client data 234 related to the customer redeeming the gift card such that the customer's next financial statement will include an indication that the gift card was redeemed. In this way, from the merchant's perspective, redemption of the gift card is transparent.

FSP device 130 may deduct the purchase price from the stored value, as discussed in detail with regard to FIG. 5, in the gift card data associated with the customer account (step 650). FSP device 130 may also deduct the purchase price from the stored value such that the deduction is transparent to the merchant. For example, FSP device 130 may authorize the purchase transaction without notifying the merchant that a gift card was previously redeemed that will be used to pay for the purchase. Instead, the gift card redemption may only be reflected in the financial service provider's records for gift card management.

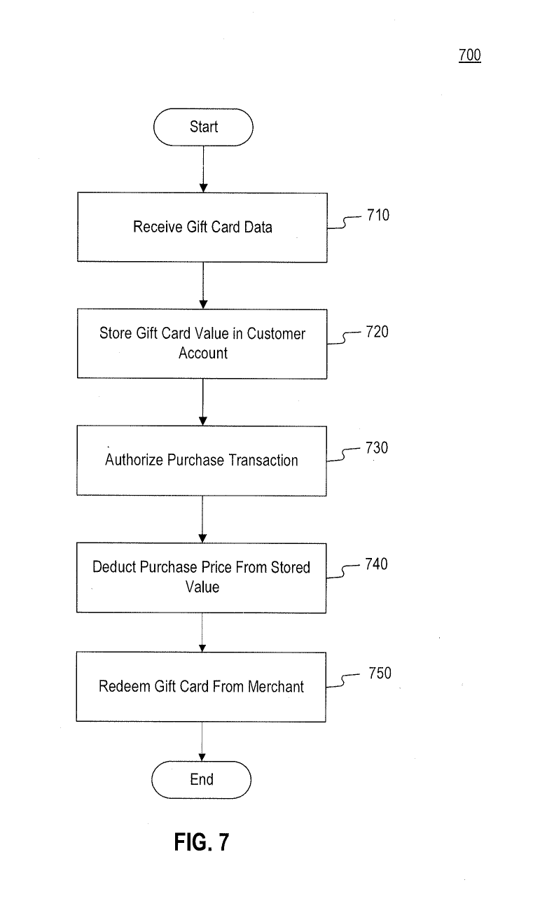

FIG. 7 shows a process for managing gift cards by a financial service provider with a back-end application, consistent with the disclosed embodiments. With a back-end application, a financial service provider may redeem the gift card from the merchant after its in-store redemption by the customer. At step 710, FSP device 130 may receive gift card data. Receiving gift card data may be accomplished in similar fashion to the previous disclosures with reference to FIGS. 3, 4, and 5. The FSP device 130 may also store the received gift card data in association with a customer account, as also disclosed in relation to FIGS. 3, 4, and 5 (step 720).

Once a user who has the gift card stored in their customer account chooses to redeem the gift card at the merchant (as discussed in detail with respect to FIGS. 3, 4, and 5), FSP device 130 may authorize the transaction (step 730). FSP device 130 may authorize the transaction in the same way it would authorize any transaction paid for by a user's debit or credit card issued by the financial service provider. FSP device 130 may then show that a gift card was redeemed in the user's financial statement. In this way, the redemption of the gift card may be conducted transparent to the merchant.

FSP device 130 may then deduct the purchase price from the stored value, as discussed in detail with regard to FIG. 5, in the gift card data associated with the customer account (step 740). This deduction may also be done transparent to the merchant, and may only be in the financial service provider's records for gift card management.

At step 750, the financial service provider may redeem the stored gift card from the merchant. In the back-end application, the financial service provider ma redeem the gift card from the merchant after the user uses it. Redeeming the gift card from the merchant, as discussed with regard to FIG. 6, may comprise contacting, for example over a network 140, the merchant that issued the gift card, and receiving from the merchant the value of the gift card. FSP device 130 may store the value of the gift card in a customer account either before or after redeeming the gift card from the merchant.

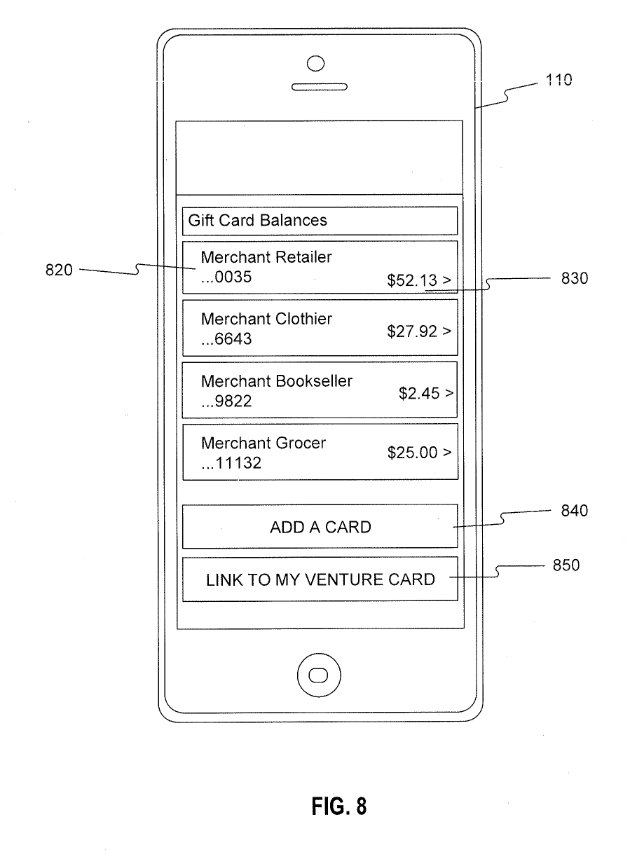

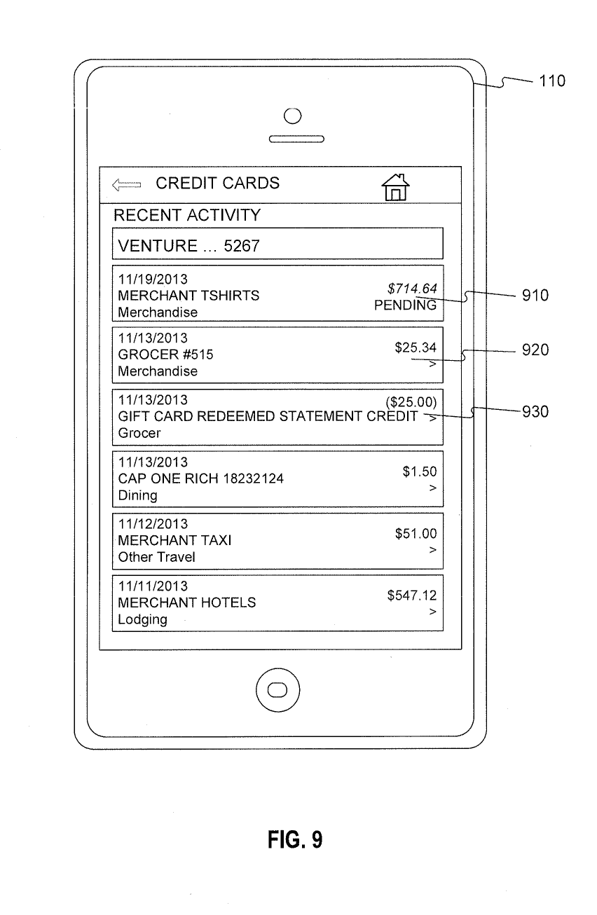

FIGS. 8 and 9 show exemplary user interfaces, consistent with some of the disclosed embodiments. For ease of discussion, the exemplary user interfaces are described with respect to user device 110. It is to be understood, however, that the gift card data may be displayed on any suitable medium consistent with disclosed embodiments. According to some embodiments of the present disclosure, and as depicted in FIGS. 8 and 9 the discount displayed to the user may be provided on user device 110. User device 110 may be a smartphone, as depicted, and may include a touch screen. Alternatively, user device 110 may be desktop computer, laptop, tablet, multifunctional watch, pair of multifunctional glasses, tracking device, or any suitable device with computing capability.

System 100 may further be configured to display to the user content that user device 110 accesses from components of system 100, including FSP device 130 and/or merchant device 120. In some embodiments, as shown in FIG. 8, user device 110 may access information about gift cards stored in a user's customer account. For example, the display may include a merchant name 820, which may indicate a merchant for which a particular user has a stored gift card. Additionally, the display may further include a stored credit value 830, which may indicate the value of the gift card the user has for a particular merchant.

System 100 may further be configured to allow a user to add additional gift cards through user device 110, as shown in FIG. 8. This may comprise a button or key 840, on user device 110 that allows a user to input additional gift cards. Further, the system may be configured to allow a user to link some or all of their stored gift cards with a credit or debit card provided by a financial service provider. This may also comprise a button or key 850 on user device 110 that allows a user to indicate that they wish to link gift cards with their debit or credit card. Linking a gift card with a debit or credit card may allow the user to pay for purchase transactions from a merchant with the gift card by paying with their debit or credit card. In this way, a user may not need a physical gift card for the merchant in order to pay for a purchase transaction with a gift card.

In other embodiments, shown in FIG. 9, the content displayed on user device 110 may include financial statements may depict multiple purchases associated with an account of the user with the financial service provider. For example, financial statements may provide a purchase transaction history that may include a summary of previous transactions associated with the user stored in, for example, memory 230 and/or database 240. Alternatively, in some embodiments, financial statements may be stored in an external storage device, such as a cloud server located outside of computing system 200. FSP device 130 may access the financial statements and I/O 220 may transmit the information over network 140 to user device 110. The history of transactions may indicate which transactions are processed, which are pending, and which were paid for using stored gift cards.

The financial statements may include financial data such as merchant name, purchase price, method of payment, and total amount charged. The financial statement may show both pending transactions 910 and completed transactions 920. Additionally, the financial statement may include indication for the method of payment such as whether a gift card was redeemed. Transactions paid for by a gift card may be shown as a credit on the account 930. For example, in some embodiments, a charge for a purchase transaction may be shown in a financial statement 920, and immediately following the charge, a credit 930 may be shown for the value of the gift card redeemed.

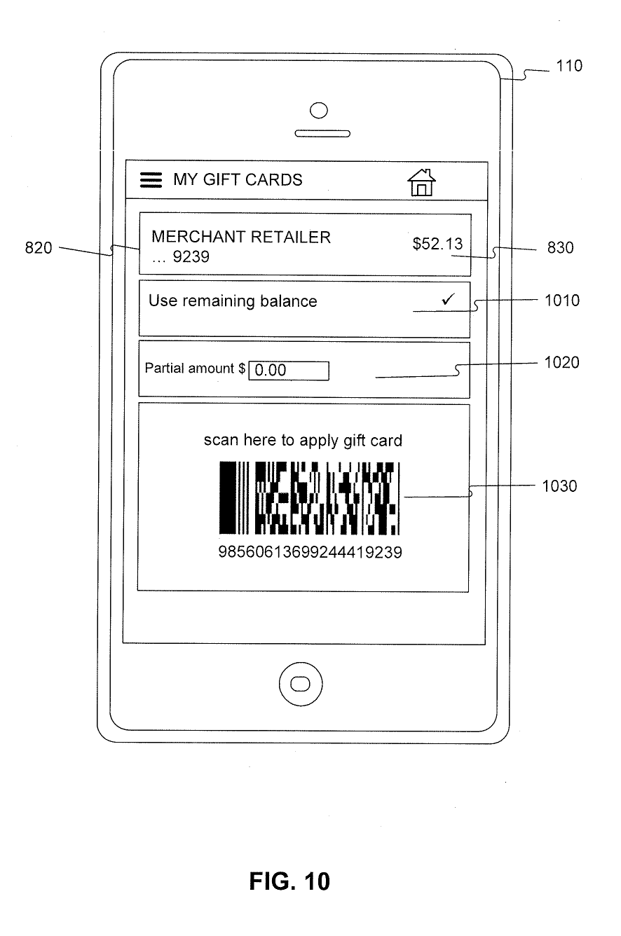

In still other embodiments, shown in FIG. 10, the content displayed on user device 110 may include an option to apply the gift card, or a portion of the gift card to a transaction. For example, the display on user device 110 may display to the user the merchant name 820 and the gift card balance 830 available for use at the merchant. User device 110 may also display to the user, buttons or keys that allow the user to decide and select whether or not to apply the gift card and also how much of the gift card to apply. For example, “use remaining balance” button 1010 may be selected by the user in order to apply the remaining balance to the purchase transaction. Alternatively, “partial amount” button 1020 may be selected by the user in order to apply less than the remaining balance of the gift card to the purchase transaction. A user may then enter into user device 110 the amount he or she wishes to apply to the transaction.

Additionally or alternatively, user device 110 may display bar code 1030. Bar code 1030 may comprise information that reflects account information. Bar code 1030 may be used in a mobile payment system. For example, in some embodiments, a merchant may scan bar code 1030 and directly apply the gift card and selected amount to the purchase transaction at the point of sale. In additional embodiments, a merchant may scan bar code 1030 in order to charge the purchase transaction to the user's debit or credit card associated with a mobile payment account with a financial service provider.

In some examples, some or all of the logic for the above-described techniques may be implemented as a computer program or application or as a plug-in module or sub component of another application. The described techniques may be varied and are not limited to the examples or descriptions provided. In some examples, applications may be developed for download to mobile communications and computing devices, e.g., laptops, mobile computers, tablet computers, smart phones, etc., being made available for download by the user either directly from the device or through a website.

Moreover, while illustrative embodiments have been described herein, the scope thereof includes any and all embodiments having equivalent elements, modifications, omissions, combinations (e.g., of aspects across various embodiments), adaptations and/or alterations as would be appreciated by those in the art based on the present disclosure. For example, the number and orientation of components shown in the exemplary systems may be modified. Further, with respect to the exemplary methods illustrated in the attached drawings, the order and sequence of steps may be modified, and steps may be added or deleted.

Thus, the foregoing description has been presented for purposes of illustration. It is not exhaustive and is not limiting to the precise forms or embodiments disclosed. Modifications and adaptations will be apparent to those skilled in the art from consideration of the specification and practice of the disclosed embodiments. For example, while a financial service provider has been described herein as the entity generating, providing, managing, and/or maintaining the gift card management program for one or more users, it is to be understood that consistent with disclosed embodiments another entity may provide such services in conjunction with or separate from a financial service provider.

The claims are to be interpreted broadly based on the language employed in the claims and not limited to examples described in the present specification, which examples are to be construed as non-exclusive. Further, the steps of the disclosed methods may be modified in any manner, including by reordering steps and/or inserting or deleting steps.

Furthermore, although aspects of the disclosed embodiments are described as being associated with data stored in memory and other tangible computer-readable storage mediums, one skilled in the art will appreciate that these aspects can also be stored on and executed from many types of tangible computer-readable media, such as secondary storage devices, like hard disks, floppy disks, or CD-ROM, or other forms of RAM or ROM. Accordingly, the disclosed embodiments are not limited to the above described examples, but instead are defined by the appended claims in light of their full scope of equivalents.

What is claimed is:

1. A system for linking a gift card with a financial account of a financial service provider, comprising:
one or more memory devices storing instructions;
one or more processors configured to execute the instructions to:
receive gift card data associated with a user, wherein the gift card data includes a credit balance of a gift card;
determine a financial account of the user with the financial service provider;
associate the gift card data with the financial account of the user;
receive transaction data for a purchase transaction of the user at a merchant, wherein the transaction data includes an identifier of the financial account of the user; and
based on the identifier of the financial account of the user, apply at least a portion of the credit balance of the gift card to the purchase transaction and apply a remaining balance of the purchase transaction to the financial account of the user.

2. The system of claim 1, wherein the gift card data further includes a merchant identifier.

3. The system of claim 1, wherein the gift card data is received over a network from a user device or a merchant device.

4. The system of claim 1, wherein the financial account of the user is a credit account associated with a credit card and the purchase transaction is initiated by a user by paying with the credit card associated with the credit account.

5. The system of claim 1, wherein the transaction data further includes a purchase price and a merchant identifier.

6. The system of claim 5, wherein the one or more processors is further configured to:
determine that the gift card data associated with the financial account of the user is applicable to the purchase transaction based on the merchant identifier; and
deduct at least a portion of the purchase price from the credit balance of the gift card.

7. The system of claim 6, wherein the one or more processors is further configured to:
determine whether the purchase price is greater than the credit balance of the gift card; and
when the purchase price is greater than the credit balance of the gift card, calculate the remaining balance by deducting the credit balance of the gift card from the purchase price.

8. The system of claim 1, wherein the one or more processors is further configured to execute the instructions to:
send a message to the user requesting confirmation to apply at least a portion of the credit balance of the gift card to the purchase transaction; and
receive a confirmation from the user to apply at least a portion of the credit balance of the gift card to the purchase transaction.

9. A computer-implemented method for linking a gift card with a financial account of a financial service provider, comprising:
receiving gift card data associated with a user, wherein the gift card data includes a credit balance of a gift card;
determining a financial account of the user with the financial service provider;
associating the gift card data with the financial account of the user;
receiving transaction data for a purchase transaction of the user at a merchant, wherein the transaction data includes an identifier of the financial account of the user; and
based on the identifier of the financial account of the user, applying at least a portion of the credit balance of the gift card to the purchase transaction and applying a remaining balance of the purchase transaction to the financial account of the user.

10. The method of claim 9, wherein the gift card data further includes a merchant identifier.

11. The system of claim 9, wherein the gift card data is received over a network from a user device or a merchant device.

12. The method of claim 9, wherein the financial account of the user is a credit account associated with a credit card and the purchase transaction is initiated by a user paying with the credit card associated with the credit account.

13. The method of claim 9, wherein the transaction data further includes a purchase price and a merchant identifier.

14. The method of claim 13, further comprising:
determining that the gift card data associated with the financial account of the user is applicable to the purchase transaction based on the merchant identifier; and
deducting at least a portion of the purchase price from the credit balance of the gift card.

15. The method of claim 14, further comprising:
determining whether the purchase price is greater than the credit balance of the gift card; and
when the purchase price is greater than the credit balance of the gift card, calculating the remaining balance by deducting the credit balance of the gift card from the purchase price.

16. The method of claim 9, further comprising:
sending a message to the user requesting confirmation to apply at least a portion of the credit balance of the gift card to the purchase transaction; and
receiving a confirmation from the user to apply at least a portion of the credit balance of the gift card to the purchase transaction.

17. A non-transitory computer-readable medium storing instructions executable by a processor to cause the processor to perform operations comprising:
receiving gift card data associated with a user, wherein the gift card data includes a credit balance of a gift card;
determining a financial account of the user with a financial service provider;
associating the gift card data with the financial account of the user;
receiving transaction data for a purchase transaction of the user at a merchant, wherein the transaction data includes an identifier of the financial account of the user and a purchase price; and
based on the identifier of the financial account of the user, applying at least a portion of the credit balance of the gift card to the purchase transaction and applying a remaining balance of the purchase transaction to the financial account of the user.

18. The non-transitory computer-readable medium of claim 17, the instructions further executable by the processor to perform operations comprising:
determining that the gift card data associated with the financial account of the user is applicable to the purchase transaction based on a merchant identifier included in the transaction data; and
deducting at least a portion of the purchase price of the purchase transaction from the credit balance of the gift card.

19. The non-transitory computer-readable medium of claim 18, the instructions further executable by the processor to perform operations comprising:
determining whether the purchase price is greater than the credit balance of the gift card; and
when the purchase price is greater than the credit balance of the gift card, calculating the remaining balance by deducting the credit balance of the gift card from the purchase price.

20. The non-transitory computer-readable medium of claim 17, the instructions further executable by the processor to perform operations comprising:
sending a message to the user requesting confirmation to apply at least a portion of the credit balance of the gift card to the purchase transaction; and
receiving a confirmation from the user to apply at least a portion of the credit balance of the gift card to the purchase transaction.
